(19) United States
(12) Patent Application Publication
(10) Pub. No.: US 2007/0131825 A1
(43) Pub. Date: Jun. 14, 2007

(54) Laptop computer stand

(76) Inventor: Thomas Skrodzki, Plano, TX (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/297,415

(22) Filed: Dec. 9, 2005

(51) Int. Cl. F16M 11/02

(52) U.S. Cl. 248/177.1

(57) ABSTRACT

A laptop computer stand including a tripod and a platform releasably attached to the top of the tripod. The platform includes a base portion for supporting a laptop computer and a number of props radiating outwardly from the base portion for grasping the corners of the laptop computer supported by the base portion. Each of the props has a slide with an inner end and an outer end and a longitudinal channel in the inner end. A pair of upstanding fins is affixed to the outer end of the slide and projects above the top of the base portion. The fins are oriented at right angles to one another to form an inwardly directed concavity for receiving a corner of the laptop computer. A number of threaded fasteners, each respectively penetrating the base portion and one of the longitudinal channels, fix the positions of the props relative to the base portion.

### FIELD OF THE INVENTION

The present invention relates generally to supports and, more particularly, to platforms for mounting articles directly above stationary stands, e.g., tripod heads.

### BACKGROUND OF THE INVENTION

Laptop computers became commercial successes by sacrificing expandability for portability. One does not usually purchase a laptop with the idea of upgrading it. One buys a laptop to have a computer anywhere. It is now common for laptops to assist their users while they are giving lectures, working outdoors, or traveling in moving vehicles.

The conventional laptop employs a keyboard and an adjacent touchpad to transmit data and instructions to a small hard drive and microprocessor positioned in a housing beneath the keyboard. Hingedly connected to the housing is a display for viewing output from the microprocessor. Unfortunately, laptop keyboards and displays are small and are difficult to see and manipulate unless such are held close to a user.

Computer users have been resourceful in supporting their laptops for easy access. Laptops are often seen perched in users' laps, balanced atop podiums, and set on train seats. One wrong move, however, can send the laptop to the floor where irreparable damage can result. In the worst case, work stored in the memory of the damaged laptop is permanently lost.

### SUMMARY OF THE INVENTION

In light of the problems associated with the known methods for positioning a laptop computer for ready access and use, it is a principal object of the invention to provide a stand that will safely support a laptop computer for a user virtually anywhere. The stand is adjustable so that the position of the laptop computer can be finely adjusted about three axes to satisfy the most finicky user.

It is another object of the invention to provide a laptop computer stand of the type described that can be employed with all known makes and models of laptop computers. Mounting of a laptop on the stand is accomplished without special tools or prolonged training.

It is a further object of the invention to provide a laptop computer stand that utilizes a conventional camera tripod to elevate the laptop above a supporting surface such as a floor or the ground. Modification of neither the tripod nor the laptop computer is required to use the stand. Furthermore, the stand does not prevent access to CD/DVD drives, ports, and other fixtures being part of the typical laptop computer.

Still another object of the invention is to provide a stand of the type described with supplemental cooling for a laptop computer to ensure that the laptop computer performs up to its maximum processing capabilities. The means for providing cooling air to the laptop computer are powered by the laptop computer's internal battery. The cooling means are energized by a user only when needed to conserve battery power. The stand is, thus, portable, reusable, and economical.

It is an object of the invention to provide improved features and arrangements thereof in a laptop computer stand for the purposes described that is lightweight in construction, inexpensive to manufacture, energy efficient, and dependable in use.

Briefly, the laptop computer stand in accordance with this invention achieves the intended objects by featuring a tripod and a platform for supporting a laptop computer atop the tripod.

The platform includes a rectangular base portion upon which a laptop computer can be positioned. The base portion has four corners and a slot in each of the corners. A number of props radiate outwardly from the base portion for grasping a laptop computer positioned thereon. Each of the props has a slide with an inner end with a longitudinal channel slidably positioned in a respective one of the slots. A pair of upstanding fins is affixed to the outer end of each slide and projects above the top of the base portion. The fins are oriented at right angles to one another so as to form an inwardly directed concavity for receiving one corner of a laptop computer. A number of threaded fasteners, each respectively penetrating one slot in the base portion and the longitudinal channel in one slide, fix the positions of the props relative to the base portion.

A pair of electric fans is optionally mounted in the base portion for cooling a laptop computer positioned upon the platform. By means of a USB plug, the fans are connected to the internal battery of the laptop computer.

The foregoing and other objects, features, and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is an exploded perspective view of a laptop computer stand in accordance with the present invention together with a laptop computer.

FIG. 2 is a perspective view of the laptop computer stand of FIG. 1 supporting a laptop computer.

FIG. 3 is a top view of the platform of the laptop computer stand.

FIG. 4 is a bottom view of the platform with portions broken away to reveal details thereof.

FIG. 5 is a side view of the platform with a clip-on tripod adapter positioned adjacent thereto.

FIG. 6 is a perspective view of a USB plug being inserted into a USB port in a laptop computer to convey electrical power therefrom.

FIG. 7 is an electrical circuit diagram for the laptop computer stand.

Similar reference characters denote corresponding features consistently throughout the accompanying drawings.

### DETAILED DESCRIPTION OF THE PREFERRED EMBODIMENT

Referring now to the FIGS., a laptop computer stand in accordance with the present invention is shown at 10. Stand 10 includes a tripod 12 to the top of which a platform 14 is releasably attached. A laptop computer 16 is positioned atop platform 14.

Tripod 12 includes three telescoping legs 18 connected at their tops by a pinnacle bracket 20. A tubular brace 22 extends downwardly from bracket 20 between legs 18. Brace 22 is reinforced at its bottom by struts 24 extending inwardly from legs 18. A pole 26 is telescopically positioned within brace 22 and can be extended upwardly from brace 22 with a light pulling force. By manipulation of bracket 20, the top of pole 26 can be locked at a desired height above brace 22.

A top pole 26 is a mounting bracket 28. Mounting bracket 28 has a mounting portion 30 affixed to the top of pole 26 and a locking portion 32 hingedly attached to mounting portion 30. A control arm 34 extending outwardly from mounting portion 30 permits mounting bracket 28 to be moved in terms of pitch and yaw. Locking portion 32 can be “rolled” by manipulation of the hinged connection between itself and mounting portion 30.

Locking portion 32 is provided with a recess 36 and its top to one side of which is positioned a pivoting wedge 38. An adapter plate 40 can be locked within recess 36 by manually pivoting wedge 38. As adapter plate 40 is affixed to the bottom of platform 14 by means of a screw 42, adapter plate 40, mounting portion 30, and wedge 38 define an uncomplicated mechanism for the “quick release” of platform 14 from tripod 12.

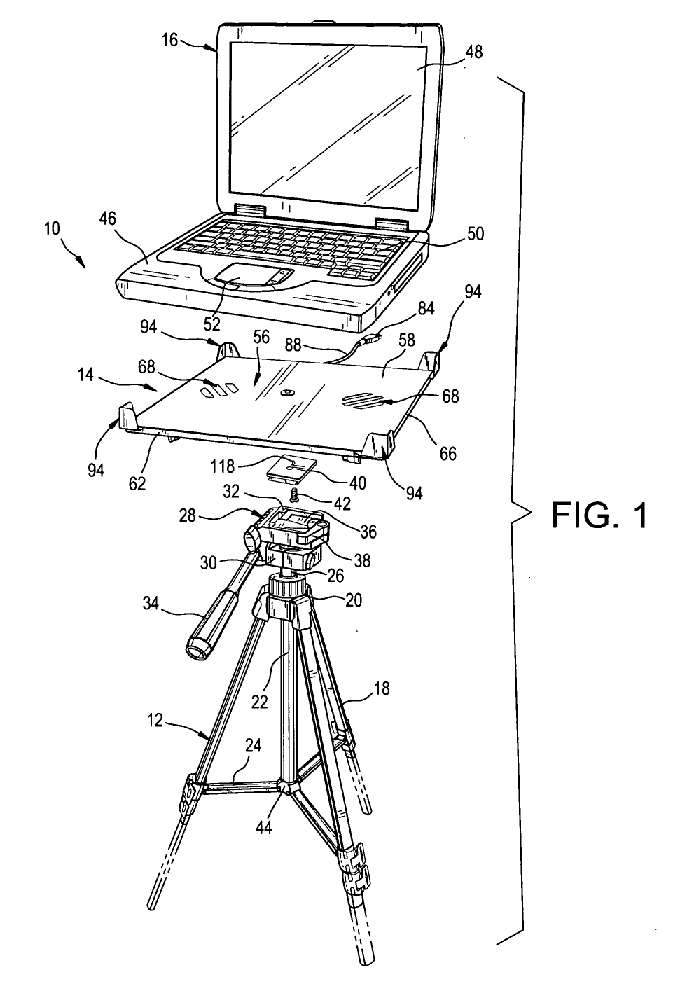

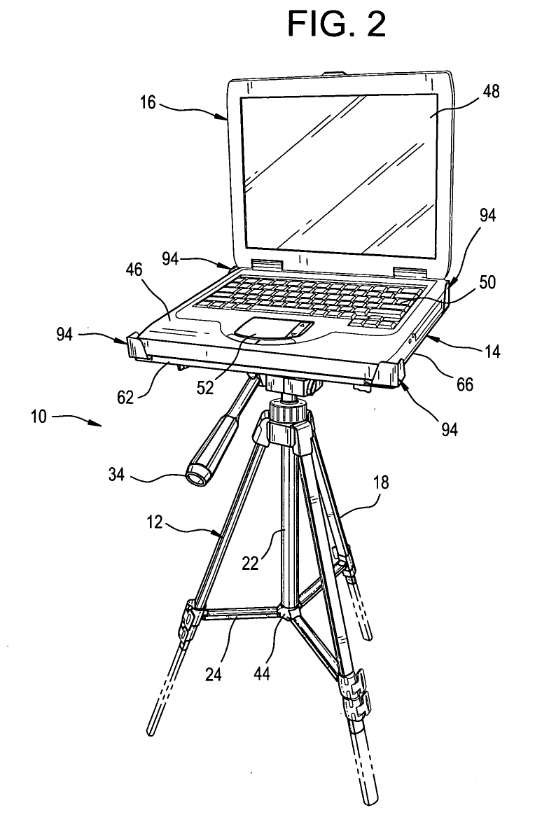

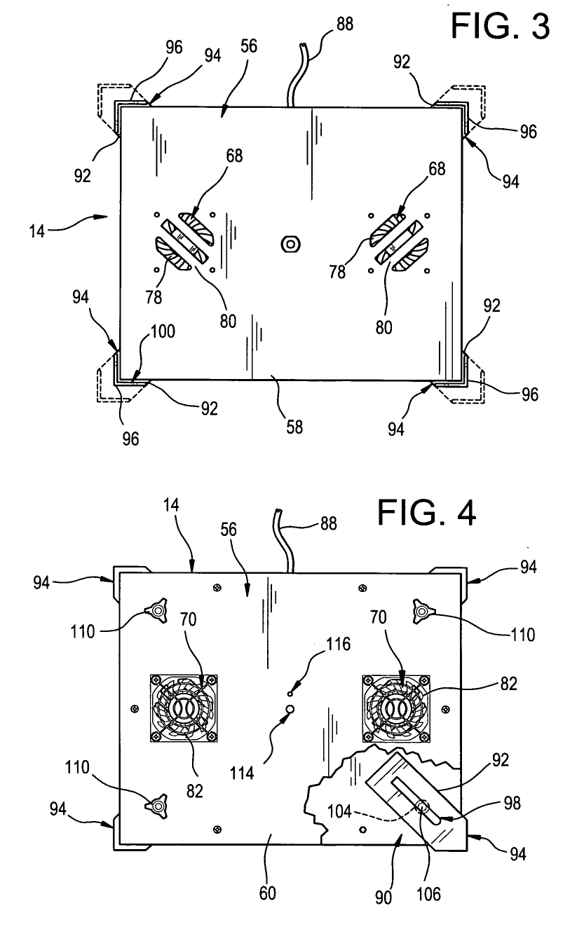

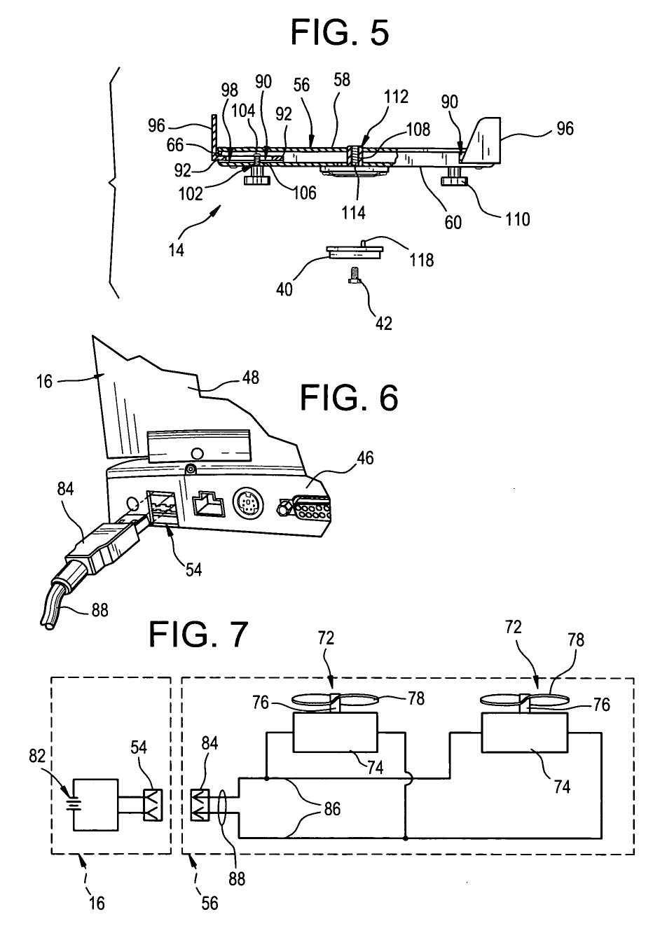

Tripod 12 is collapsible. In this regard, legs 18 are hingedly connected to pinnacle bracket 20 and the outer ends of struts 24. The inner ends of struts 24 are connected to a ring 44 that slides upon tubular brace 22. So, the bottoms of legs 18 can be pulled outwardly from one another to the extent permitted by struts 24 to form a stable support as shown in FIGS. 1 and 2 or can, by elevating ring 44 on brace 22, be pushed together so that tripod 12 can be compactly stored. Legs 18, being capable of telescoping in the usual manner, can be extended to the broken line positions shown in FIGS. 1 and 2 or retracted to the solid line positions illustrated therein.

Laptop computer 16 has a rectangular housing 46 to which a display 48 is hingedly attached. The top of housing 46 supports a keyboard 50 and a touchpad 52 for inputting data and commands into a central processing unit and memory (neither shown) within housing 46. When computer 16 is not being used, display 48 is normally folded downwardly upon keyboard 50 in clamshell-like fashion for protective storage. The back of housing 46 is provided with at least one USB port 54 for attaching peripheral devices, like a copier, scanner, or camera, to computer 16, but which can be used as an electrical power source as will be described hereinbelow.

Platform 14 comprises a base portion 56 having a top wall 58 and a bottom wall 60 connected together about their peripheries by: a front wall 62, a back wall 64, and a pair of opposed side walls 66. Top wall 58 is provided with a pair of laterally spaced air outlet openings 68. Similarly, bottom wall 60 has a pair of laterally spaced air inlet openings 70 that that are axially aligned with outlet openings 68.

Mounted within platform 14 is a pair of fans 72. Each fan 72 is positioned between one aligned pair of inlet and outlet openings 70 and 68. Each fan 72 includes an electric motor 74, operating on direct current, having a rotatable driveshaft 76 that carries an impeller blade 78. For safety, a pair of cover gratings 80 and 82 affixed within openings 68 and 70 shields blade 78. When energized, fans 72 draw air into inlet openings 70 from the environment and eject such upwardly from outlet openings 68.

Fans 72 are energized by connecting such to a rechargeable battery 82 with provided within laptop computer 16. Battery 82 normally powers computer 16 but can be tapped as an electrical current source via USB port 54 (or PS/2 socket, not shown) normally located in the back of housing 46. Simply inserting USB plug 84 at the ends of electrical leads 86 extending from motors 74 into USB port 54 is all that is required to energize motors 74. Removing plug 84 from port 54 is all that is required to deenergized motors 74.

Plug 84 is positioned at the terminal ends of electrical leads 86 extending from motors 74 that are connected in parallel with one another. To protect leads 86, they are sheathed together in the form of a cable 88. Cable 88 extends from back wall 64 of platform 14 and can have any desired length although a length of a few inches is sufficient.

At the four corners of platform 14, at the junctions of front wall 62 and back wall 64 with side walls 66, slots 90 are provided by cutting away portions of walls 62, 64, and 66. Each slot 90 provides access to the interior of platform 14 and is dimensioned to snugly receive the slide 92 of a prop 94 for supporting one of the four corners of laptop housing 46.

Each prop 94 has a slide 92 and a pair of upstanding fins 96 affixed to slide 92. Slide 92 is an elongated bar with a channel 98 extending along its center. Fins 96 are joined to one another at right angles and are positioned at the outer end of slide 92. Fins 96 project above the top of platform 14 to form concavities as at 100 in each prop 94 for receiving and grasping one of the four corners of computer housing 46.

When slides 92 are pushed to their fullest extent into slots 90, fins 96 fit flush against adjacent walls 62 or 64 and 66 for compact storage and use with computers with small housings. When, however, slides 92 are extended part way from slots 90, fins 96 can receive the four corners of a larger computer housing such as the one shown at 16.

Threaded fasteners 102 are provided for setting the positions of props 94 relative to base portion 56. Each of fasteners 102 has a head 104 positioned atop one of slides 92 and a threaded shaft 106 extending downwardly through a channel 98 from head 104. The bottom of each threaded shaft 106 projects through one of a number of close-fitting bores 108 in bottom wall 60 located adjacent each of slots 90. A knurled nut or knob 110 is screwed onto the bottom of each threaded shaft 106 for selectively clamping a slide 92 in place against bottom wall 60 thereby setting the extension of a prop 94 from a slot 90. It should be noted that if knobs 110 are made from plastic, they can effectively serve as non-marring legs for platform 14 when it is used away from tripod 12 on a tabletop or podium.

A screw boss 112 with a threaded bore 114 is affixed within an opening at the center of bottom wall 60 to receive the screw 42 that attaches adapter plate 40 to platform 14. Preferably, boss 112 engages both bottom wall 60 and top wall 58 to reinforce platform 14 at its center. Adjacent boss 112, an alignment bore 116 is provided in bottom wall 60 to receive an alignment pin 118 projecting upwardly from adapter plate 40 adjacent screw 42.

Use of laptop computer stand 10 is straightforward. First, with stand 10 in the configuration shown in FIG. 1, adapter plate 40 is screwed onto the bottom of platform 14. Next, the positions of props 94 are adjusted so that fins 96 snugly grasp the four corners of laptop computer housing 46 and are affixed by tightening knobs 110. Then, platform 14 is set atop mounting bracket 28 with adapter plate 40 set in recess 36 and locked there by manually pivoting wedge 38. Now, tripod 12, with platform 14 joined to it, is positioned in a convenient location and computer housing 46 is set atop platform 14. Finally, computer 16 is energized and used in the convenient manner.

Should supplemental cooling for computer 16 be desired, USB plug 84 need only be inserted into USB port 54 to energize fans 72 to blow air upwardly into one or more air inlets (not shown) in the bottom of computer housing 46. The entire set-up process requires approximately one minute to complete. A person taking down and disassembling stand 10 needs about the same amount of time. After disassembly, all of stand 10 can be conveniently stored and transported with laptop computer 16 in a briefcase or other carrier for immediate reuse.

While the invention has been described with a high degree of particularity, it will be appreciated by those skilled in the art that modifications may be made to it. For example, tripods, other than those utilizing a quick release adapter plate 40, can be used in association with platform 14 and laptop computer 16. Most of these tripods are simply provided with mounting brackets having upwardly extending screws and alignment pins. Thus, attachment and detachment of platform 14 from another tripod may take a few seconds longer to complete than with tripod 12 described above but the stand assembled with such a tripod would offer substantially the same benefits as stand 10. Therefore, it is to be understood that the present invention is not limited to the sole embodiment described above, but encompasses any and all embodiments within the scope of the following claims.

I claim:

1. A laptop computer stand, comprising:
a tripod;
a platform being releasably attached to the top of said tripod, said platform including:
a base portion for supporting a laptop computer;
a plurality of props radiating outwardly from said base portion for grasping the corners of a laptop computer positioned on said base portion, each of said props having:
a slide with an inner end and an outer end and a longitudinal channel in said inner end; and,
a pair of upstanding fins being affixed to said outer end of said slide and projecting above the top of said base portion, said fins being oriented at right angles to one another so as to form an inwardly directed concavity for receiving one corner of a laptop computer; and,
a plurality of threaded fasteners, each respectively penetrating said base portion and one said longitudinal channel for fixing the positions of said props relative to said base portion.

2. The laptop computer stand according to claim 1 wherein said tripod includes a screw for fastening the top thereof to another object and said base portion of said platform includes a threaded bore for threadably receiving said screw.

3. The laptop computer stand according to claim 1 further comprising an electric fan in said base portion for impelling air from the top of said platform into a laptop computer positioned thereon.

4. The laptop computer stand according to claim 3 further comprising a plug being adapted for connection to a laptop computer for delivering electrical current to said fan so as to power said fan.

5. A platform for supporting a laptop computer upon a tripod, said platform comprising:
a base portion upon which a laptop computer can be positioned;
a plurality of props radiating outwardly from said base portion for grasping the corners of a laptop computer positioned on said base portion, each of said props having:
a slide with an inner end and an outer end and a longitudinal channel in said inner end; and,
a pair of upstanding fins being affixed to said outer end of said slide and projecting above the top of said base portion, said fins being oriented at right angles to one another so as to form an inwardly directed concavity for receiving one corner of a laptop computer; and,
a plurality of threaded fasteners, each respectively penetrating said base portion and one said longitudinal channel for fixing the positions of said props relative to said base portion.

6. The platform according to claim 5 said base portion includes a threaded bore for threadably receiving a screw extending upwardly from the tripod and an alignment bore adjacent said threaded bore for receiving an alignment pin extending upwardly from the tripod.

7. The platform according to claim 5 further comprising an electric fan mounted in said base portion for impelling air from the top of said base portion into a laptop computer positioned thereon.

8. The platform according to claim 7 further comprising a plug being adapted for connection to a laptop computer port to deliver electrical current to said fan.

9. A platform for supporting a laptop computer upon a tripod, said platform comprising:
a rectangular base portion upon which a laptop computer can be positioned, said base portion having four corners and a slot in each of said corners;
a plurality of props radiating outwardly from said base portion for grasping a laptop computer positioned upon said base portion, each of said props having:
a slide with an inner end slidably positioned in a respective one said slot and an outer end and a longitudinal channel in said inner end; and,
a pair of upstanding fins being affixed to said outer end of said slide and projecting above the top of said base portion, said fins being oriented at right angles to one another so as to form an inwardly directed concavity for receiving one corner of a laptop computer; and,
a plurality of threaded fasteners, each respectively penetrating one slot in said base portion and said longitudinal channel in one said slide, for fixing the positions of said props relative to said base portion.

10. The platform according to claim 9 said base portion includes a threaded bore at its center for threadably receiving a screw extending upwardly from the tripod and an alignment bore adjacent said threaded bore for receiving an alignment pin extending upwardly from the tripod.

11. The platform according to claim 9 further comprising a pair of electric fans mounted in said base portion for impelling air from the top of said base portion into a laptop computer positioned thereon.

12. The platform according to claim 11 further comprising a plug being adapted for connection to a laptop computer port to deliver electrical current to said pair of electric fans.
